(19) United States
(12) Patent Application Publication
(10) Pub. No.: US 2012/0271566 A1
(43) Pub. Date: Oct. 25, 2012

(54) METHOD FOR THE PREDICTION OF FATIGUE LIFE FOR STRUCTURES

(76) Inventors: Vinayak Deshmukh, Pune (IN); Eric M. Johnson, Geneseo, IL (US)

(21) Appl. No.: 13/091,943

(22) Filed: Apr. 21, 2011

(51) Int. Cl. G06F 19/00

(52) U.S. Cl. 702/42

(57) ABSTRACT

A method of determining the fatigue life of a structure includes the steps of:
associating a mathematical equation for total strain amplitude with the structure:

$$\frac{Δɛ}{2} = \frac{{σ}_{f}^{′}}{E} {( 2 {N}_{f} )}^{b} + {{ɛ}_{f}^{′} ( 2 {N}_{f} )}^{c} ,$$

where: Δε/2=strain amplitude, σf′=fatigue strength coefficient associated with a material of the structure, b=fatigue strength exponent of the material, E=cyclic modulus of elasticity of the material, 2Nf=number of cycles, εf′=fatigue ductility coefficient of the material, and c=fatigue ductility exponent of the material;
reducing the fatigue strength exponent (b) such that an elastic portion of a total strain amplitude curve associated with the equation has a reduced slope to account for variable amplitude loading for the structure;
generating a total strain amplitude curve, based upon the mathematical equation:

$$\frac{Δɛ}{2} = \frac{{σ}_{f}^{′}}{E} {( 2 {N}_{f} )}^{{b}_{reduced}} + {{ɛ}_{f}^{′} ( 2 {N}_{f} )}^{c} ,$$

where (b_{reduced}) is now the reduced fatigue strength exponent; and
determining a fatigue life of the structure, based on the total strain amplitude curve with the reduced fatigue strength exponent.

### FIELD OF THE INVENTION

The present invention relates to methods for determining the structural integrity of a chassis in work vehicles, and, more particularly, to analysis methods for determining the fatigue life of structures in such work vehicles.

### BACKGROUND OF THE INVENTION

Work vehicles, such as agricultural, construction, forestry or mining work vehicles, typically include a chassis carrying a body and a prime mover in the form of an internal combustion engine. The chassis may also carry other structural components, such as a front-end loader, a backhoe, a grain harvesting header, a tree harvester such as a feller-buncher, etc.

The chassis itself typically includes a number of structural frame members which are welded together. The size and shape of the frame members varies with the particular type of work vehicle. Given the external loads which are applied to the work vehicle, it is also common to use reinforcing gusset plates and the like at the weld locations of the frame members to ensure adequate strength.

With any such type of work vehicle, it is of course necessary to ensure that the chassis of the vehicle is sufficiently strong to withstand externally applied loads, vibration, etc. over an expected long life of the vehicle. Over the past couple of decades, the use of finite element analysis (FEA) techniques has become increasingly more common to analyze both dynamic and static loads which are applied to the chassis of the vehicle. Typically a three dimensional (3D) model of the structure to be analyzed is generated, with the 3D model including a number of nodes defined by a 3D coordinate system. An FEA model (software program) is used to calculate the dynamic and/or static loads at each of the nodes. This type of FEA analysis is typically always done with a computer because of the computational horse-power required to calculate the loads at each of the nodes.

The FEA analysis provides a peak stress value which is then utilized in a strain based model to calculate the fatigue life of the chassis of the vehicle. The strain based model uses a mathematical equation in which constants and variables in the equation are derived from physical properties associated with a material from which the chassis is constructed. These material properties are established through standard testing techniques, and are used as input values in the equation. The problem with the current methodology for calculating strain parameters for variable amplitude loading is that the data fitting of the material properties involves judgment which may vary from one person to another. Current methods lose variability of the fatigue test data as very few samples are included for curve fitting of the material properties. This leads to over conservative prediction for constant amplitude loading at long life, which may lead to overdesign of the structural components. Current methods also do not predict the variation in fatigue life due to variability in material properties. The current methodology may take up to one week to fit material properties for a single material; thus, due to cost, testing is often limited to a single heat and used throughout for the particular grade of material. Finally, the current methodology does not adequately fit data for variable amplitude loading on the structural components.

What is needed in the art is a method of accurately determining the fatigue life of structures such as welded structures in work vehicles used in variable amplitude loading situations.

### SUMMARY

The present invention provides a method of determining the fatigue life of a structure in which the fatigue strength exponent (b) (based on the material of the structure) is reduced to account for variable amplitude loading on the structure. The amount that the fatigue strength exponent (b) is reduced depends on the material of the structure, specifically a material family of the material.

The invention in one form is directed to a method of determining the fatigue life of a structure, including the steps of:

associating a mathematical equation for total strain amplitude with the life of the structure:

$$\frac{Δɛ}{2} = \frac{{σ}_{f}^{′}}{E} {( 2 {N}_{f} )}^{b} + {{ɛ}_{f}^{′} ( 2 {N}_{f} )}^{c} ,$$

where: Δε/2=strain amplitude, σf′=fatigue strength coefficient associated with a material of the structure, b=fatigue strength exponent of the material, E=cyclic modulus of elasticity of the material, 2Nf=number of cycles, εf′=fatigue ductility coefficient of the material, and c=fatigue ductility exponent of the material;

reducing the fatigue strength exponent (b) such that an elastic portion of a total strain amplitude curve associated with the equation has a reduced slope to account for variable amplitude loading for the structure;

generating a total strain amplitude curve, based upon the mathematical equation:

$$\frac{Δɛ}{2} = \frac{{σ}_{f}^{′}}{E} {( 2 {N}_{f} )}^{{b}_{reduced}} + {{ɛ}_{f}^{′} ( 2 {N}_{f} )}^{c} ,$$

where (b_{reduced}) is now the reduced fatigue strength exponent; and
determining a fatigue life of the structure, based on the total strain amplitude curve with the reduced fatigue strength exponent.

The invention in another form is directed to a method of determining the fatigue life of a structure, including the steps of:

associating a mathematical equation for elastic strain amplitude with the structure:

$$\frac{Δɛ}{2} = \frac{{σ}_{f}^{′}}{E} {( 2 {N}_{f} )}^{{b}_{i}} ,$$

where: Δε/2=strain amplitude, σf=fatigue strength coefficient associated with a material of the structure, b=fatigue strength exponent of the material, E=cyclic modulus of elasticity of the material, and 2Nf=number of cycles;

reducing the fatigue strength exponent (b) such that an elastic strain amplitude curve associated with the equation has a reduced slope to account for variable amplitude loading for the structure;

generating an elastic strain amplitude curve, based upon the mathematical equation:

$$\frac{Δɛ}{2} = \frac{{σ}_{f}^{′}}{E} {( 2 {N}_{f} )}^{{b}_{reduced}} ,$$

where (b_{reduced}) is now the reduced fatigue strength exponent; and

determining a fatigue life of the structure, based on the elastic strain amplitude curve with the reduced fatigue strength exponent.

The invention in yet another form is directed to a computer-based method of determining the fatigue life of a structure using a computer having at least one processor and at least one memory. The method includes the following steps which are each sequentially carried out within the computer:

associating a mathematical equation for total strain amplitude with the structure:

$$\frac{Δɛ}{2} = \frac{{σ}_{f}^{′}}{E} {( 2 {N}_{f} )}^{b} + {{ɛ}_{f}^{′} ( 2 {N}_{f} )}^{c} ,$$

where: Δε/2=strain amplitude, σf′=fatigue strength coefficient associated with a material of the structure, b=fatigue strength exponent of the material, E=cyclic modulus of elasticity of the material, 2Nf=number of cycles, εf′=fatigue ductility coefficient of the material, and c=fatigue ductility exponent of the material;

reducing the fatigue strength exponent (b) such that an elastic portion of a total strain amplitude curve associated with the equation has a reduced slope to account for variable amplitude loading for the structure;

generating a total strain amplitude curve, based upon the mathematical equation:

$$\frac{Δɛ}{2} = \frac{{σ}_{f}^{′}}{E} {( 2 {N}_{f} )}^{{b}_{reduced}} + {{ɛ}_{f}^{′} ( 2 {N}_{f} )}^{c} ,$$

where (b_{reduced}) is now the reduced fatigue strength exponent; and

determining a fatigue life of the structure, based on the total strain amplitude curve with the reduced fatigue strength exponent.

### BRIEF DESCRIPTION OF THE DRAWINGS

The above-mentioned and other features and advantages of this invention, and the

manner of attaining them, will become more apparent and the invention will be better understood by reference to the following description of an embodiment of the invention taken in conjunction with the accompanying drawings, wherein:

FIG. 1 is a block diagram illustrating a multi-axial state of stress at a weld toe location of a welded T joint structure;

FIG. 2 is illustrates the critical cross-sections (along with relevant stress components to be extracted, e.g., extract σxx if section-1 is critical or extract σyy if section-2 is critical) in the welded T joint structure shown in FIG. 1;

FIG. 3 is an example of a constant amplitude stress history;

FIG. 4 is an example of a variable amplitude fatigue stress history;

FIG. 5 is a strain-life curve with a selected fatigue life (2Nf);

FIG. 6 illustrates a reduction factor based upon a material family;

FIG. 7 is a graphical illustration of a reduced fatigue strength exponent, resulting in a reduced slope on the elastic strain amplitude curve;

FIG. 8 illustrates a total total strain amplitude curve showing a reduction in life in the long life region due to the reduction in the fatigue strength exponent;

FIG. 9 is a schematic block diagram of a computer which may be used to carry out the method of the present invention for the prediction of fatigue life for structures; and

FIG. 10 is a flowchart illustrating a portion of an embodiment of the method of the present invention for determining the fatigue life of a structure.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION

Referring now to the drawings, the method of the present invention for determining the fatigue life of a structure will be described in greater detail. In the illustrated embodiment, the structure is assumed to be a welded structure, but could be a different type of structure for which it is desirable to determine a fatigue life associated therewith. For example, the structure could be a plate with one or more holes causing localized stress concentrations.

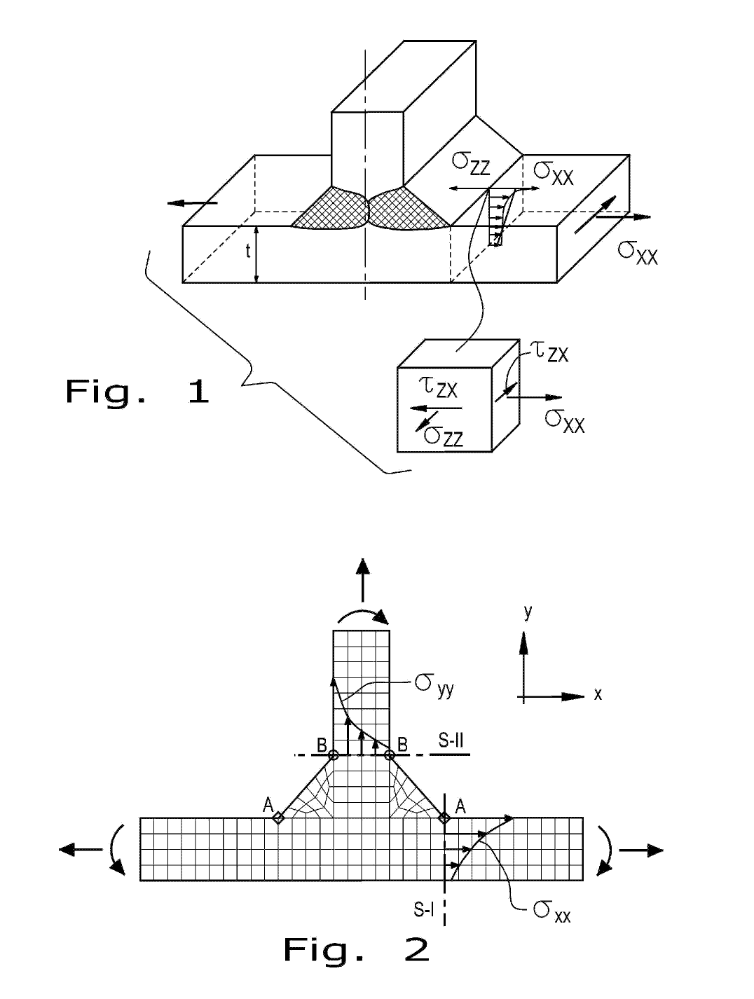

The welded structure shown in FIG. 1 is assumed to be a 3D geometry of a double fillet T-joint including all geometrical details. Such a structure can be often modeled using either 3D coarse or 3D fine FE mesh. When the coarse FE mesh is used the weld toe is modeled as a sharp corner as shown in FIG. 2. Critical cross sections, i.e., all sections containing the weld toe and the critical points in those sections are denoted by points A and B in both the attachment and the base plate, respectively. The cross section S-I represents the weld toe cross section in the base plate and the cross section S-II represents the weld toe cross section in the attachment, respectively. The cross sections S-I and S-II are located at the transition between the weld and the plate.

The transition points (points A and B) or the adjacent points experience the highest stress concentration. Stresses σₓₓ(y) in the base plate cross section S-I are needed for the fatigue analysis of the base plate and stresses σ_{yy}(x) in the cross section S-II are needed for the fatigue analysis of the attachment. The peak amplitude of the stress (peak stress) and the mean stress of each stress cycle are needed for the fatigue life prediction based on the local strain-life approach. The through thickness stress distribution and its fluctuations are necessary for Fracture Mechanics analyses. Various known methods for determining the peak stress at an identified critical stress location may be used and are not described in further detail herein.

The total strain on the structure at an identified location is a function of the peak stress as described above. The Ramberg-Osgood equation describes the non-linear relationship between stress and strain; that is, the stress-strain curve, in materials near their yield points. It is especially useful for metals that harden with plastic deformation, showing a smooth elastic-plastic transition. The cyclic stress-strain curve described by the Ramberg-Osgood relationship is represented by the mathematical function:

$$ε = \frac{σ}{E} + {K ( \frac{σ}{E} )}^{n}$$

Where ε is the true total strain amplitude, σ is the cyclically stable true stress amplitude, E is the cyclic Young's modulus of elasticity, and K and n are constants that depend on the material being considered. Specifically, K is the cyclic strength coefficient, and n is the cyclic strain hardening exponent. The first term on the right side, σ/E, is equal to the elastic part of the strain, while the second term, K(σ/E)ⁿ, accounts for the plastic part, the parameters K and n describing the hardening behavior of the material. The total strain could also be determined using other methodologies, such as by using measurement techniques.

The total strain amplitude (Δε₎ is thus a function of the sum of the elastic strain amplitude (Δεₑ) and the plastic strain amplitude (Δεₚ). Therefore, the total strain amplitude may also be represented by the equation:

Δε=Δεₑ+Δεₚ.

Where the stress is high enough for plastic deformation to occur, the plastic strain amplitude (Δεₚ) from low-cycle fatigue is usually characterized by the Coffin-Manson equation (published independently by L. F. Coffin in 1954 and S. S. Manson in 1953):

$$\frac{{Δɛ}_{p}}{2} = {{ɛ}_{f}^{′} ( 2 {N}_{f} )}^{c}$$

where:

$$\frac{{Δɛ}_{p}}{2}$$

is the plastic strain amplitude

$$( \frac{{Δɛ}_{p}}{2} = \frac{{Δɛ}_{measured}}{2} - \frac{{Δɛ}_{measured}}{2 E} ) ,$$

ε_{f}′ is an empirical constant known as the fatigue ductility coefficient, the failure strain for a single reversal;

2N is the number of reversals to failure (N cycles); and

c is an empirical constant known as the fatigue ductility exponent, commonly ranging from −0.5 to −0.7 for metals in time independent fatigue. Slopes can be considerably steeper in the presence of creep or environmental interactions.

Likewise, where the stress is not high enough for plastic deformation to occur, the elastic strain amplitude (Δεₑ) is usually characterized by the equation:

$$\frac{{Δɛ}_{e}}{2} = \frac{{σ}_{f}^{′}}{E} {( 2 {N}_{f} )}^{b}$$

where:

$$\frac{{Δɛ}_{e}}{2}$$

is the elastic strain amplitude

$$( \frac{{Δɛ}_{e}}{2} = \frac{{Δɛ}_{measured}}{2} - \frac{{Δɛ}_{p}}{2} ) ,$$

σ_{f}′ is the fatigue strength coefficient, and

b is the fatigue strength exponent.

Since Δε=Δεₑ+Δεₚ, and substituting equations for Δεₑ and Δεₚ from above, then:

$$\frac{Δɛ}{2} = \frac{{σ}_{f}^{′}}{E} {( 2 {N}_{f} )}^{b} + {{ɛ}_{f}^{′} ( 2 {N}_{f} )}^{c}$$

Where:

$$\frac{Δɛ}{2}$$

is the total strain amplitude

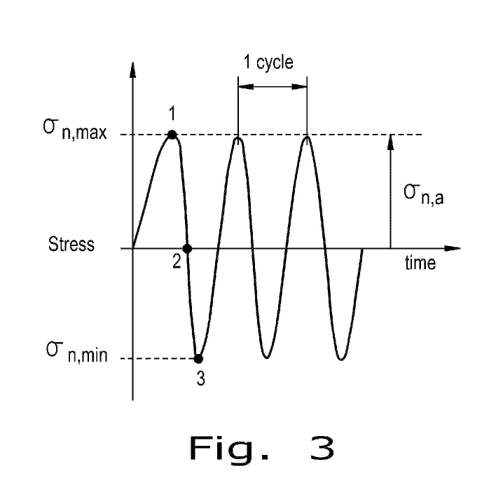

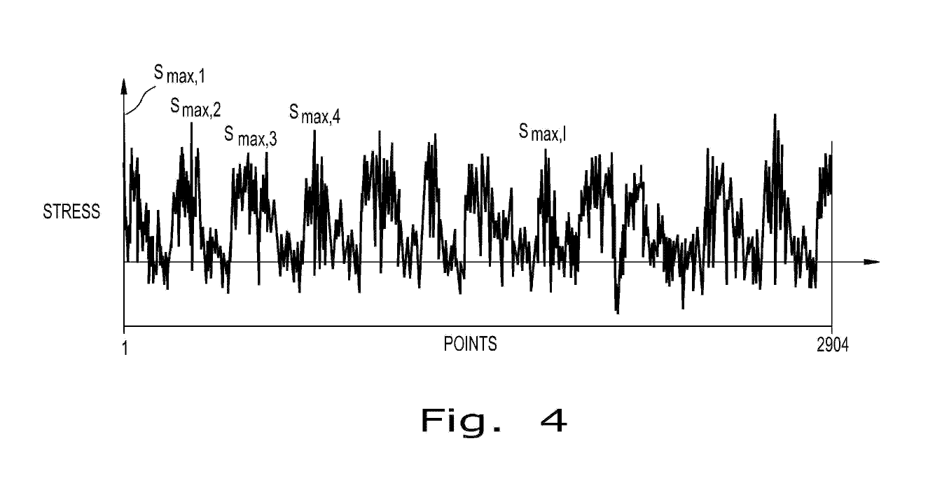

Fatigue life prediction methods based upon the total strain amplitude rely on material properties that have been developed under constant amplitude fatigue testing. An example of a constant amplitude stress applied to a structure is shown in FIG. 3. There are very few engineering components that operate under constant amplitude loading cycles. The majority of components operate under variable amplitude loading. An example of a variable amplitude fatigue stress history is shown in FIG. 4. To account for the variable amplitude loading the contribution of fatigue damage for each cycle is determined. When the summation of the damage is equal to a predetermined percentage of life (usually 1 which represents 100% of the life) the component is said to have reached its life.

Research has shown that this method of accounting for damage in variable amplitude loading in some situations is non-conservative especially in long life predictions. It is known by the assignee of the present invention to use a strain life fitting method which excludes some or all elastic strain data points in the long life region.

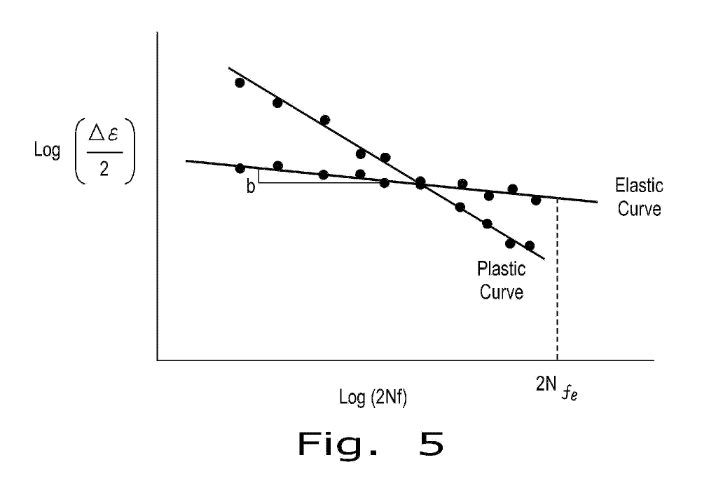

According to an aspect of the present invention, the problems associated with historic data fitting methods are overcome by fitting all relevant points in the elastic portion of the strain life curve and then reducing the fatigue strength exponent a consistent value based on the material family. The data fitting method of the present invention which accounts for all the relevant points in the elastic stress amplitude curve but does not have the adjusted fatigue strength coefficient is referred to herein as the “long life fit”. The total stress amplitude curve with the adjusted fatigue strength exponent is referred to herein as the “variable amplitude fit”. According to another aspect of the present invention, the method for converting the long life fit to the variable amplitude fit is described in greater detail in the following steps.
1. Select a fatigue life (2N_{fe}) at which the fatigue strength coefficient will be scaled. One approach is to use a selected fatigue life which is typically defined at 1.0×10E6 cycles (2×10E6 reversals) for ferrous materials and 5×10E8 cycles for aluminum and other materials which do not exhibit endurance limit behavior. (FIG. 5).
2. Substitute the selected fatigue life (2N_{fe}) into the Manson-Coffin equation for 2N_{f} to solve for the strain amplitude (Δε/2) at the selected fatigue life. The other fatigue parameters used in the Manson-Coffin equation are from long life fit.

$$\frac{Δɛ}{2} = \frac{{σ}_{f}^{′}}{E} {( 2 {N}_{f} )}^{b} + {{ɛ}_{f}^{′} ( 2 {N}_{f} )}^{c}$$

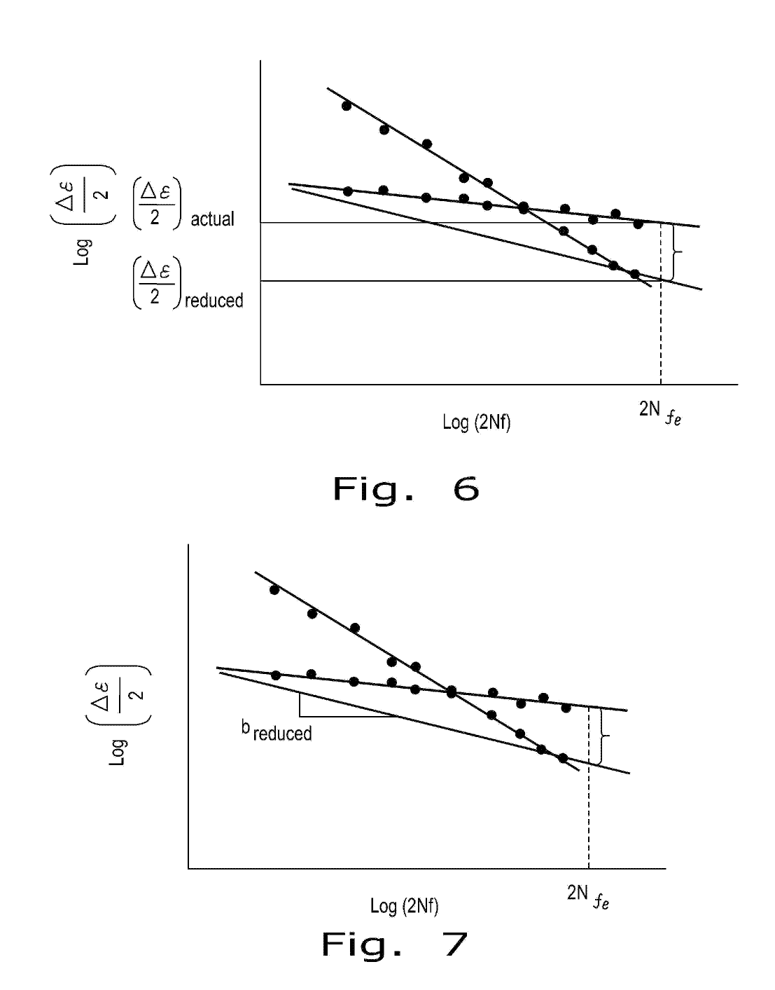

3. Use the reduction factor associated with the material family to reduce the calculated strain amplitude at 2N_{fe}. (FIG. 6).

$${( \frac{Δɛ}{2} )}_{reduced} = {( \frac{Δɛ}{2} )}_{initial} ( 1 - r ) ,$$

where r is the reduction factor in percent.
4. With the reduced strain amplitude and 2N_{fe}, back calculate the adjusted fatigue strength exponent using the Manson-Coffin equation. (FIG. 7).

$${b}_{reduced} = \frac{ln ( ( {\frac{Δɛ}{2} }_{reduced} - {{ɛ}_{f}^{′} ( 2 {N}_{{f}_{e}} )}^{c} ) ( \frac{E}{{σ}_{f}^{′}} ) )}{ln ( 2 {N}_{{f}_{e}} )}$$

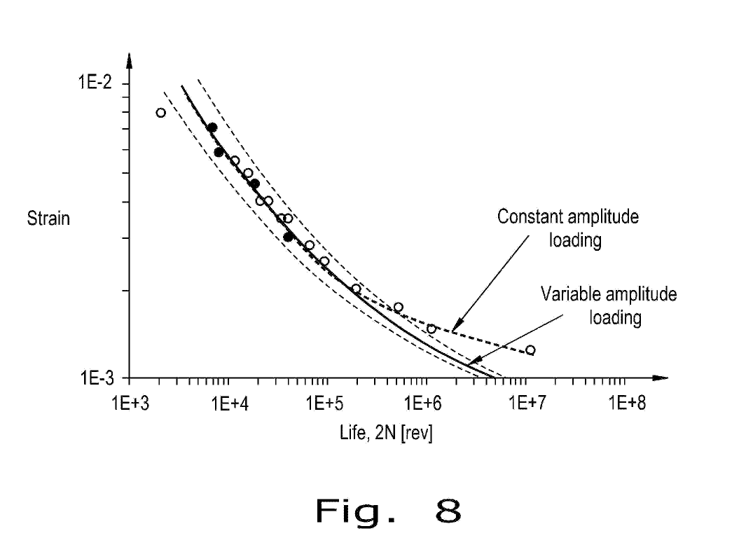

5. Perform fatigue life calculation with reduced fatigue strength exponent and other fatigue life parameters from the long life fit. (FIG. 8).

$$\frac{Δɛ}{2} = \frac{{σ}_{f}^{′}}{E} {( 2 {N}_{f} )}^{{b}_{reduced}} + {{ɛ}_{f}^{′} ( 2 {N}_{f} )}^{c}$$

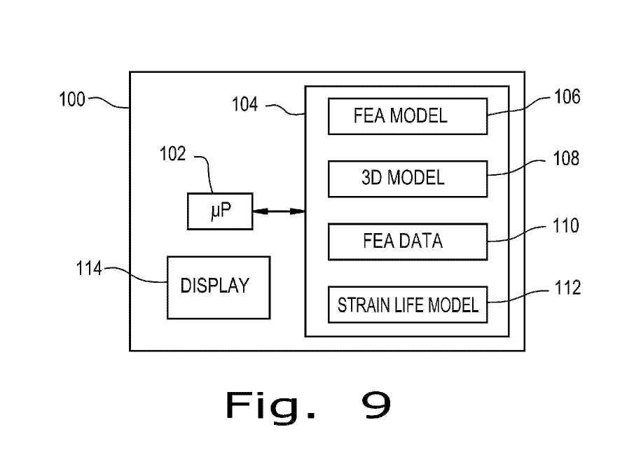

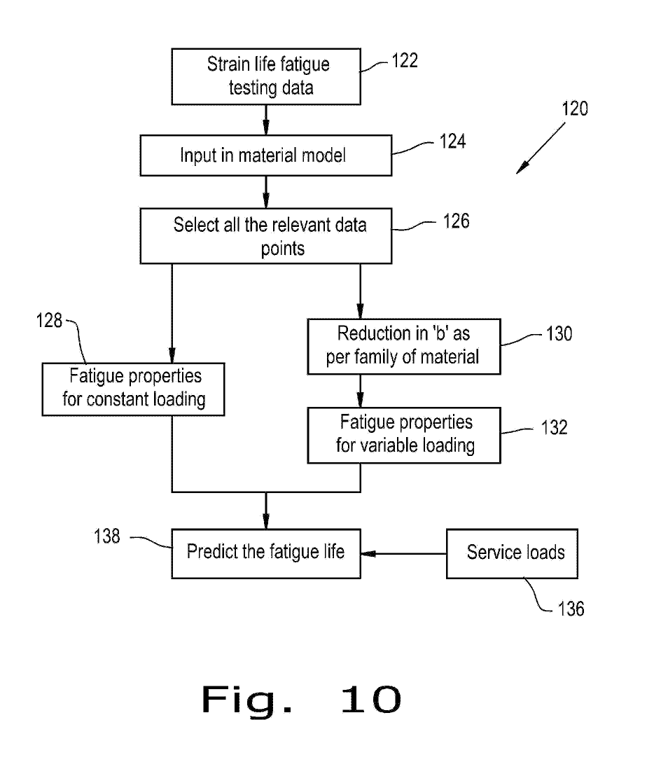

Referring now to FIG. 9, there is shown a block diagram of a computer which may be used for carrying out the computer-based method of the present invention for determining the fatigue life of a structure, such as a welded structure. Computer 100 generally includes at least one processor 102 and at least one memory 104. In the illustrated embodiment, computer 100 includes a single processor 102 and a single memory 104, but may include a different number of processors and memories connected together as appropriate, depending upon the particular application. Processor 102 is configured as a microprocessor with a sufficient operating speed. Memory 104 may include software and/or data stored therein at discrete memory locations, such as FEA model 106, 3D model 108, FEA data 110 and strain life model 112. The FEA data 110 is the output data from the FEA model 106, based upon the data of the 3D model 108. Strain life model 112 is the software program used to calculate the total strain and the fatigue life of the structure at a particular location. Discrete memory blocks or sections within memory 104 may be used to store the FEA model 106, 3-D model data 108, FEA data 110 and/or strain life model 112. Computer 100 may also include an integral or attached display 114 for displaying data, calculated results, graphs, etc. to a user.

It will be appreciated that the particular configuration of computer 100 shown in FIG. 9 is for exemplary purposes only, and the particular configuration of computer 100 may vary, depending upon the application. For example, FEA model 106 and strain life model 112 could be combined into a single software program. Alternatively, strain life model 112 could be split into multiple software programs which interface with each other. Moreover, the peak stress calculated using FEA model 106 could be calculated using a different type of software program, with the resultant output data used as an input to strain life model 112. Other configurations are also possible.

Referring now to FIG. 10, there is shown a portion of a generalized flowchart of the method 120 of the present invention for determining the fatigue life of a structure, such as a welded structure, which may be carried out using the computer 100 shown in FIG. 9. Method 100 is only directed toward the strain life model 112 (FIG. 9) used to estimate the fatigue life of the structure. As described above, an input to strain life model 112 is the peak stress at a particular location on the structure. The peak stress or strain may be calculated using an FEA model 106, or other known methodologies. At blocks 122 and 124, the strain life fatigue testing data and material model are input into the strain life model 112, respectively. At block 126, the relevant data points on the total strain amplitude curve are selected, excluding plastic strain data less than 3% of the total strain and run out data. For constant amplitude loading, the total strain amplitude equation with the normal (b) value of the fatigue strength exponent is utilized in the Manson-Coffin equation, described above (block 128). On the other hand, for variable amplitude loading, the total strain amplitude equation with the reduced (b) value of the fatigue strength exponent is utilized in the Manson-Coffin equation, described above (blocks 130 and 132). The properties as well as the service loads (block 136) are then used to predict the fatigue life of the structure (block 138).

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of determining the fatigue life of a structure, said method comprising the steps of:
associating a mathematical equation for total strain amplitude with the structure:
$$\frac{Δɛ}{2} = \frac{{σ}_{f}^{′}}{E} {( 2 {N}_{f} )}^{b} + {{ɛ}_{f}^{′} ( 2 {N}_{f} )}^{c} ,$$
where: Δε/2=strain amplitude, σf′=fatigue strength coefficient associated with a material of the structure, b=fatigue strength exponent of the material, E=cyclic modulus of elasticity of the material, 2Nf=number of cycles, εf′=fatigue ductility coefficient of the material, and c=fatigue ductility exponent of the material;
reducing the fatigue strength exponent (b) such that an elastic portion of a total strain amplitude curve associated with the equation has a reduced slope to account for variable amplitude loading for the structure;
generating a total strain amplitude curve, based upon the mathematical equation:
$$\frac{Δɛ}{2} = \frac{{σ}_{f}^{′}}{E} {( 2 {N}_{f} )}^{{b}_{reduced}} + {{ɛ}_{f}^{′} ( 2 {N}_{f} )}^{c} ,$$
where (b_{reduced}) is now the reduced fatigue strength exponent; and
determining a fatigue life of the structure, based on the total strain amplitude curve with the reduced fatigue strength exponent.

2. The method of determining a fatigue life of a structure of claim 1, wherein said step of reducing the fatigue strength exponent (b) causes the elastic strain amplitude curve to have a slope which more closely approximates a slope of the plastic strain amplitude curve.

3. The method of determining a fatigue life of a structure of claim 1, wherein the fatigue strength exponent (b) is based on a material from which the structure is made at the identified location.

4. The method of determining a fatigue life of a structure of claim 3, wherein the fatigue strength exponent (b) is scaled dependent upon a material family of the material from which the structure is made at the identified location.

5. The method of determining a fatigue life of a structure of claim 1, wherein said reducing step includes selecting a fatigue life (2N_{f}), substituting the selected fatigue life into the mathematical equation associated with the total strain amplitude curve, and calculating the total strain amplitude at the selected fatigue life.

6. The method of determining a fatigue life of a structure of claim 5, wherein the selected fatigue life is dependent upon a material family of the material from which the structure is made.

7. The method of determining a fatigue life of a structure of claim 6, wherein the selected fatigue life is approximately 1.0×10E+6 for ferrous materials and 1.0×10E+8 for aluminum.

8. The method of determining a fatigue life of a structure of claim 6, wherein said reducing step includes calculating a reduced total strain amplitude at the selected fatigue life, dependent upon a reduction factor associated with the material family of the material from which the structure is made at the identified location.

9. The method of determining a fatigue life of a structure of claim 8, wherein the reduction factor is based upon the mathematical equation:
$${( \frac{Δɛ}{2} )}_{reduced} = {( \frac{Δɛ}{2} )}_{initial} ( 1 - r ) ,$$
where r is the reduction factor in percent.

10. The method of determining a fatigue life of a structure of claim 8, wherein said reducing step includes back calculating the reduced fatigue strength exponent, based on the reduced total strain amplitude and the selected fatigue life (2N_{f}), using the mathematical equation associated with the total strain amplitude curve:
$${b}_{reduced} = \frac{ln ( ( {\frac{Δɛ}{2} }_{reduced} - {{ɛ}_{f}^{′} ( 2 {N}_{{f}_{e}} )}^{c} ) ( \frac{E}{{σ}_{f}^{′}} ) )}{ln ( 2 {N}_{{f}_{e}} )}$$

11. The method of determining a fatigue life of a structure of claim 1, wherein the structure is a welded structure with a weld having a weld toe angle and a weld toe radius.

12. A method of determining the fatigue life of a structure, said method comprising the steps of:
associating a mathematical equation for elastic strain amplitude with the structure:
$$\frac{Δɛ}{2} = \frac{{σ}_{f}^{′}}{E} {( 2 {N}_{f} )}^{{b}_{i}} ,$$
where: Δε/2=strain amplitude, σf′=fatigue strength coefficient associated with a material of the structure, b=fatigue strength exponent of the material, E=cyclic modulus of elasticity of the material, and 2Nf=number of cycles;
reducing the fatigue strength exponent (b) such that an elastic strain amplitude curve associated with the equation has a reduced slope to account for variable amplitude loading for the structure;
generating an elastic strain amplitude curve, based upon the mathematical equation:
$$\frac{Δɛ}{2} = \frac{{σ}_{f}^{′}}{E} {( 2 {N}_{f} )}^{{b}_{reduced}} ,$$
where (b_{reduced}) is now the reduced fatigue strength exponent; and
determining a fatigue life of the structure, based on the elastic strain amplitude curve with the reduced fatigue strength exponent.

13. A computer-based method of determining the fatigue life of a structure using a computer having at least one processor and at least one memory, said method comprising the following steps which are each sequentially carried out within the computer:
associating a mathematical equation for total strain amplitude with the structure:
$$\frac{Δɛ}{2} = \frac{{σ}_{f}^{′}}{E} {( 2 {N}_{f} )}^{b} + {{ɛ}_{f}^{′} ( 2 {N}_{f} )}^{c} ,$$
where: Δε/2=strain amplitude, σf′=fatigue strength coefficient associated with a material of the structure, b=fatigue strength exponent of the material, E=cyclic modulus of elasticity of the material, 2Nf=number of cycles, εf′=fatigue ductility coefficient of the material, and c=fatigue ductility exponent of the material;
reducing the fatigue strength exponent (b) such that an elastic portion of a total strain amplitude curve associated with the equation has a reduced slope to account for variable amplitude loading for the structure;
generating a total strain amplitude curve, based upon the mathematical equation:
$$\frac{Δɛ}{2} = \frac{{σ}_{f}^{′}}{E} {( 2 {N}_{f} )}^{{b}_{reduced}} + {{ɛ}_{f}^{′} ( 2 {N}_{f} )}^{c} ,$$
where (b_{reduced}) is now the reduced fatigue strength exponent; and
determining a fatigue life of the structure, based on the total strain amplitude curve with the reduced fatigue strength exponent.

14. The computer-based method of determining the fatigue life of a structure of claim 13, wherein the 3D coarse mesh model is stored within the at least one memory of the computer.

15. The computer-based method of determining the fatigue life of a structure of claim 13, wherein the FEA data is stored within the at least one memory of the computer.

16. The computer-based method of determining the fatigue life of a structure of claim 15, wherein the FEA model provides instructions to the processor to generate the FEA data.
